(19) United States
(12) Patent Application Publication
(10) Pub. No.: US 2020/0014128 A1
(43) Pub. Date: Jan. 9, 2020

(54) CABLE WITH TERMINAL AND METHOD OF MANUFACTURING THE SAME

(71) Applicant: Yazaki Corporation, Tokyo (JP)

(72) Inventors: Hideki SAITO, Shizuoka (JP); Kazuhide Takahashi, Shizuoka (JP); Kei Sato, Shizuoka (JP)

(73) Assignee: Yazaki Corporation, Tokyo (JP)

(21) Appl. No.: 16/460,318

(22) Filed: Jul. 2, 2019

(30) Foreign Application Priority Data
Jul. 6, 2018 (JP) 2018-128743

(51) Int. Cl. H01R 4/18; H01R 13/52; H01R 4/62; H01R 13/03; H01R 43/048

(52) U.S. Cl. CPC H01R 4/185; H01R 13/5216; H01R 43/048; H01R 13/03; H01R 4/62

(57) ABSTRACT

A cable with a terminal includes a cable and a crimp terminal. In the cable, a core wire is covered with an insulating sheath. A crimp terminal has a core wire crimping portion and a sheath crimping portion. The core wire crimping portion is crimped to the core wire exposed from the insulating sheath. The sheath crimping portion is crimped to the insulating sheath. An anticorrosion tape material is stuck around the crimping portion of the crimp terminal.

### CROSS REFERENCE TO RELATED APPLICATION

This application is based upon and claims the benefit of priority from the prior Japanese Patent Application No. 2018-128743, filed on Jul. 6, 2018, the entire contents of which are incorporated herein by reference.

### BACKGROUND

### 1. Technical Field

The present invention relates to a cable with a terminal subjected to anticorrosion treatment and a method of manufacturing the same.

### 2. Related Art

For example, a cable with a terminal subjected to anticorrosion treatment has been disclosed in Patent Literature 1 (JP 2016-110894 A). The cable with a terminal includes a terminal and an aluminum cable. A sheath crimping portion of the terminal is crimped to an insulating sheath of the aluminum cable. The sheath crimping portion is covered with a sheet-like member. A welding portion is a connection portion between the terminal and a core wire exposed from the insulating sheath of the aluminum cable. A circumference of the sheet-like member and the welding portion are sealed by a heat-shrinkable tube which is shrunk under heat.

The sheet-like member is provided at a position where it is likely to be broken when contacting the heat-shrinkable tube in the terminal. In addition, the heat-shrinkable tube is shrunk by a heating device such as a heater to cover the circumference of the welding portion and the sheath crimping portion without a gap.

### SUMMARY

However, in the conventional cable with a terminal, the heat-shrinkable tube is assembled after the sheet-like member is wound around the sheath crimping portion, so the number of steps is increased and productivity is reduced. In addition, in the conventional cable with a terminal, the sheet-like member and the heat-shrinkable tube are required, which increases costs.

An object of the present invention is to provide a high-productivity and inexpensive cable with a terminal and a method of manufacturing the same, which can prevent electrolytic corrosion of a core wire simply and reliably.

According to an embodiment, there is provided a cable with a terminal, comprising: a cable which has a core wire covered with an insulating sheath; and a crimp terminal which has a crimping portion including a core wire crimping portion crimped to the core wire exposed from the insulating sheath and a sheath crimping portion crimped to the insulating sheath, wherein an anticorrosion tape material is stuck around the crimping portion of the crimp terminal.

According to an embodiment, there is provided a method of manufacturing a cable with a terminal which includes a cable which has a core wire covered with an insulating sheath, and a crimp terminal which has a crimping portion including a core wire crimping portion crimped to the core wire exposed from the insulating sheath and a sheath crimping portion crimped to the insulating sheath, the method comprising: winding an anticorrosion tape material around the crimping portion of the crimp terminal after the cable is crimped and connected to the crimping portion of the crimp terminal.

According to the embodiments, the electrolytic corrosion of the core wire of the cable can be prevented simply and reliably by winding the anticorrosion tape material around the crimping portion of the crimp terminal. Therefore, the productivity can be improved and the costs can be reduced.

### BRIEF DESCRIPTION OF DRAWINGS

FIG. 1A is a perspective view of a cable with a terminal according to a first embodiment of the present invention;

FIG. 1B is a perspective view of a cable with a terminal in a state in which an anticorrosion tape material is attached to a crimping portion of the terminal;

FIG. 2 is a cross-sectional view taken along the line X-X in FIG. 1B;

FIG. 3A is a perspective view illustrating a state in which an anticorrosion tape material is set on a sticking jig with an adhesive surface of the anticorrosion tape material facing up;

FIG. 3B is a side view illustrating the state in which the anticorrosion tape material is set on the sticking jig with the adhesive surface of the anticorrosion tape material facing up;

FIG. 4A is a perspective view illustrating a state in which the terminal is set on the adhesive surface of the anticorrosion tape material;

FIG. 4B is a side view illustrating the state in which the terminal is set on the adhesive surface of the anticorrosion tape material;

FIG. 5A is a perspective view illustrating a state in which the terminal is pressed against a recess portion of the sticking jig;

FIG. 5B is a side view illustrating the state in which the terminal is pressed against the recess portion of the sticking jig;

FIG. 6A is a perspective view illustrating a state in which the adhesive surfaces of the anticorrosion tape material are stuck to each other and cut;

FIG. 6B is a side view illustrating the state in which the adhesive surfaces of the anticorrosion tape material are stuck to each other and cut;

FIG. 7A is a perspective view of a cable with a terminal according to a second embodiment of the present invention;

FIG. 7B is a perspective view of a cable with a terminal in a state in which an anticorrosion tape material is attached to a crimping portion of the terminal;

FIG. 8 is a cross-sectional view taken along the line Y-Y in FIG. 7B;

FIG. 9 is a perspective view illustrating a state in which the terminal is set on the adhesive surface of the anticorrosion tape material;

FIG. 10A is a perspective view sequentially illustrating a step of rotating and winding the terminal on the adhesive surface of the anticorrosion tape material;

FIG. 10B is a perspective view sequentially illustrating a step of rotating and winding the terminal on the adhesive surface of the anticorrosion tape material;

FIG. 10C is a perspective view sequentially illustrating a step of rotating and winding the terminal on the adhesive surface of the anticorrosion tape material;

FIG. 10D is a perspective view sequentially illustrating a step of rotating and winding the terminal on the adhesive surface of the anticorrosion tape material;

FIG. 10E is a perspective view sequentially illustrating a step of rotating and winding the terminal on the adhesive surface of the anticorrosion tape material;

and

FIG. 11 is a perspective view illustrating a state in which the anticorrosion tape material is cut after the sticking of the anticorrosion tape material is completed.

### DETAILED DESCRIPTION

Hereinafter, embodiments of the present invention will be described with reference to the accompanying drawings.

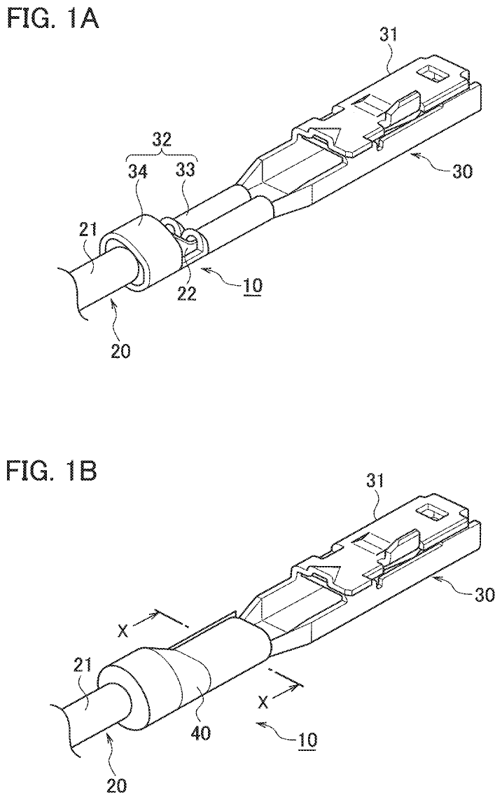

A first embodiment will be described with reference to FIGS. 1A to 6B.

As illustrated in FIGS. 1A and 1B, a cable 10 with a terminal includes a cable 20 and a crimp terminal 30 made of metal. In the cable 20, a core wire 22 is covered with an insulating sheath 21. The crimp terminal 30 has a box-shaped terminal connection portion 31 and a crimping portion 32.

The terminal connection portion 31 is formed on a front side of the crimp terminal 30. The other terminal is electrically connected to the terminal connection portion 31. The crimping portion 32 has a core wire barrel (core wire crimping portion) 33 and a sheathed barrel (sheath crimping portion) 34. The core wire barrel 33 is crimped to the core wire 22 exposed from the insulating sheath 21 at a rear side from a center of the crimp terminal 30. The sheathed barrel 34 is crimped to the insulating sheath 21.

An anticorrosion tape material 40 is stuck around the crimping portion 32 of the crimp terminal 30.

In the cable 10 with a terminal, the core wire 22 of the cable 20 and the crimp terminal 30 are each made of different metals. For example, the core wire 22 is formed of a wire rod of aluminum or an aluminum alloy. The crimp terminal 30 is made of a member in which a base material of a copper alloy is plated with a tin alloy or the like. In this case, a bare portion of the core wire 22 in contact with the crimp terminal 30 is likely to be electrolytically corroded (corroded) due to different metal contact corrosion (galvanic corrosion). Therefore, the circumference of the crimping portion 32 of the crimp terminal 30 where a bare portion of the core wire 22 is exposed, is covered with the anticorrosion tape material 40 to prevent electrolytic corrosion.

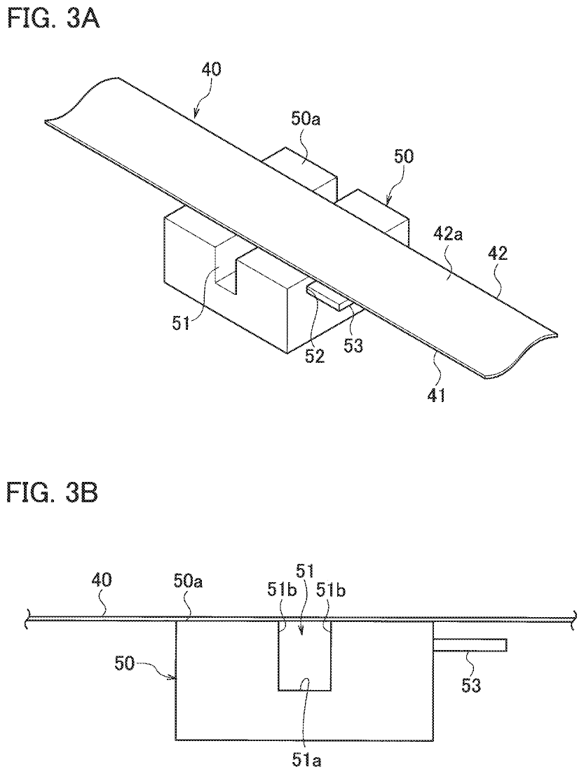

The anticorrosion tape material 40 has, for example, a laminated structure including a tape-like base material 41, such as an expandable acrylic tape, a wrap, and a rubber sheet, that does not pass water, or an adhesive layer 42 formed on the base material 41 (See FIG. 3A).

Next, a method of manufacturing a cable 10 with a terminal will be described in order along FIGS. 3A to 6B.

By a caulking die formed of a crimper, an anvil, and the like, the core wire 22 exposed from the insulating sheath 21 of the cable 20 is crimped to the core wire barrel 33 of the crimp terminal 30 beforehand, and the insulating sheath 21 of the cable 20 is crimped and connected to the sheathed barrel 34 of the crimp terminal 30.

As illustrated in FIGS. 3A and 3B, the anticorrosion tape material 40 is set on an upper surface 50a of a sticking jig 50 to straddle a groove-like recess portion 51 of a sticking jig 50, with an adhesive surface (bonded surface) 42a of the anticorrosion tape material 40 facing up.

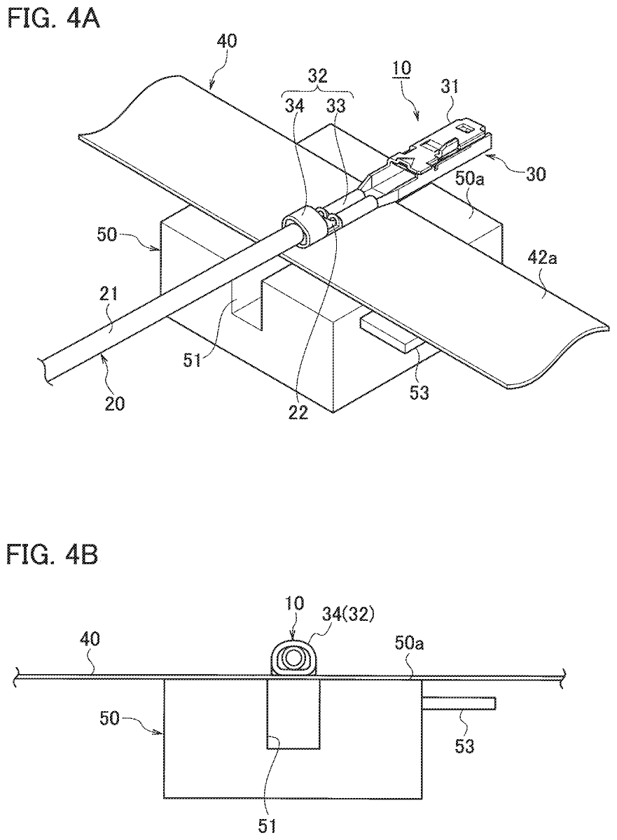

Next, as illustrated in FIGS. 4A and 4B, the crimping portion 32 including the core wire barrel 33 and the sheathed barrel 34 of the crimp terminal 30 is set on the anticorrosion tape material 40 set on the recess portion 51 of the sticking jig 50.

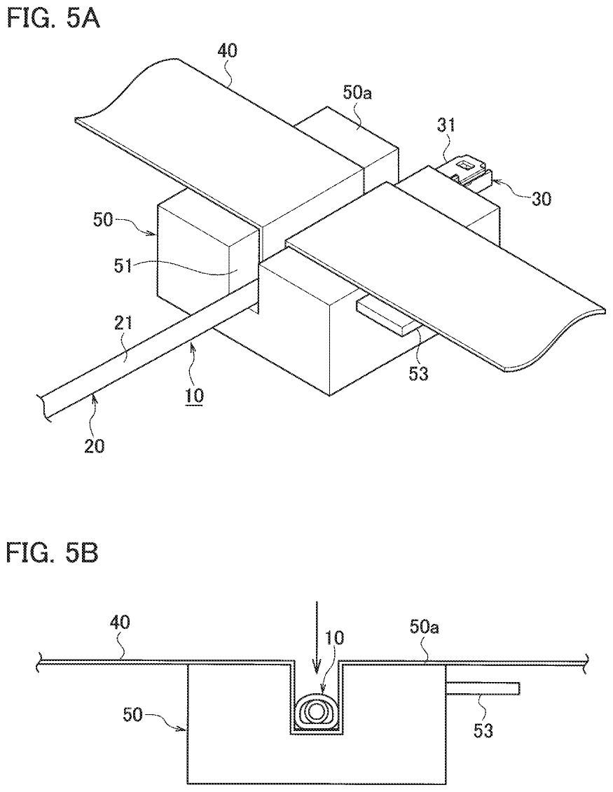

Then, as illustrated in FIGS. 5A and 5B, a pressing device (not illustrated) presses the crimping portion 32 of the crimp terminal 30 against a bottom surface 51a of the recess portion 51 of the sticking jig 50 with the anticorrosion tape material 40 interposed therebetween.

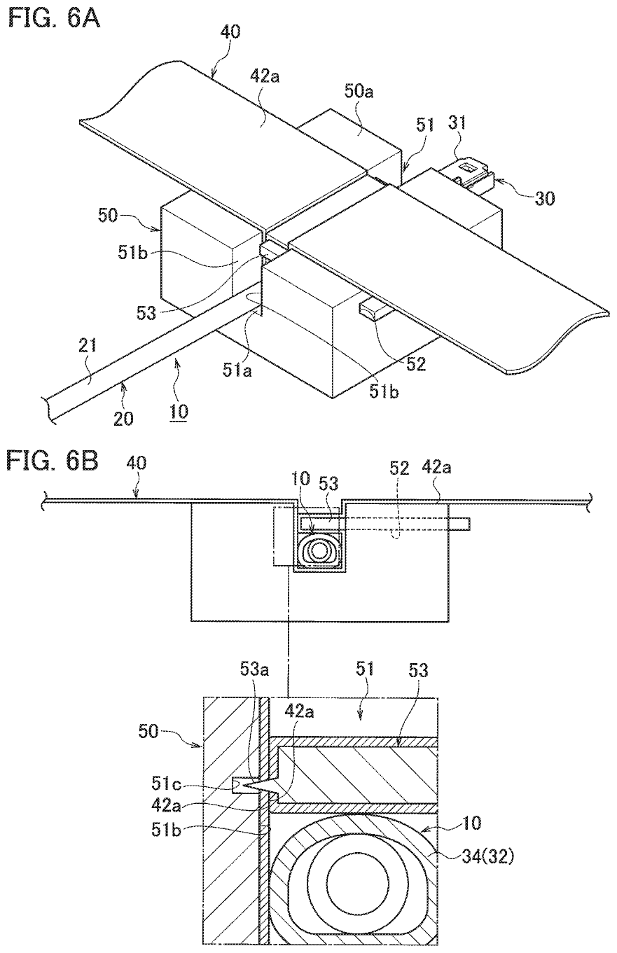

Next, as illustrated in FIGS. 6A and 6B, by pressing the crimping portion 32 of the crimp terminal 30, the adhesive surfaces (bonded surfaces) 42a of the anticorrosion tape material 40 pressed against the bottom surface 51a and both side surfaces 51b of the recess portion 51 of the sticking jig 50, are stuck to each other by a tape cutter 53 provided in a through hole 52 which penetrates through the recess portion 51 of the sticking jig 50. The adhesive surfaces 42a of the anticorrosion tape material 40 bonded to each other are cut with a blade edge 53a of the tape cutter 53 in a lateral groove recess 51c provided on one side surface 51b of the recess portion 51 communicating with the through hole 52.

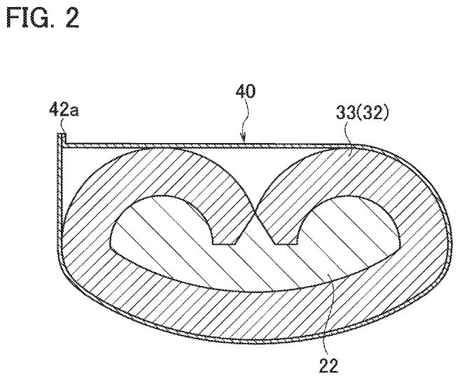

Thereby, as illustrated in FIG. 2, the anticorrosion tape material 40 is stuck and bonded around the crimping portion 32 of the crimp terminal 30. That is, the adhesive surfaces 42a of the anticorrosion tape material 40 are stuck to each other in a state where the crimp terminal 30 is restrained in the recess portion 51 of the sticking jig 50, and the anticorrosion tape material 40 is stuck around the crimping portion 32 of the crimp terminal 30.

As illustrated in FIG. 2, there is a partial gap between the crimping portion 32 of the crimp terminal 30 and the anticorrosion tape material 40 stuck around the crimping portion 32. The anticorrosion tape material 40 may be further pressed against the gap between the anticorrosion tape material 40 and the crimping portion 32 to eliminate the gap.

As described above, the anticorrosion tape material 40 is stuck around the crimping portion 32 of the crimp terminal 30 in the state where the adhesive surfaces 42a of the adhesive layer 42 of the anticorrosion tape material 40 are stuck to each other. Thereby, the electrolytic corrosion (different metal contact corrosion) of the core wire 22 of the cable 20 can be prevented simply and reliably.

By sticking the anticorrosion tape material 40 around the crimping portion 32 of the crimp terminal 30, the electrolytic corrosion of the core wire 22 of the cable 20 can be prevented, so the lifetime of the crimping portion 32 can be extended.

By sticking the anticorrosion tape material 40 around the crimping portion 32 of the crimp terminal 30, the electrolytic corrosion of the core wire 22 of the cable 20 can be prevented, so the improvement in productivity and the cost reduction can be achieved. In addition, there is no need to change the conventional terminal structure.

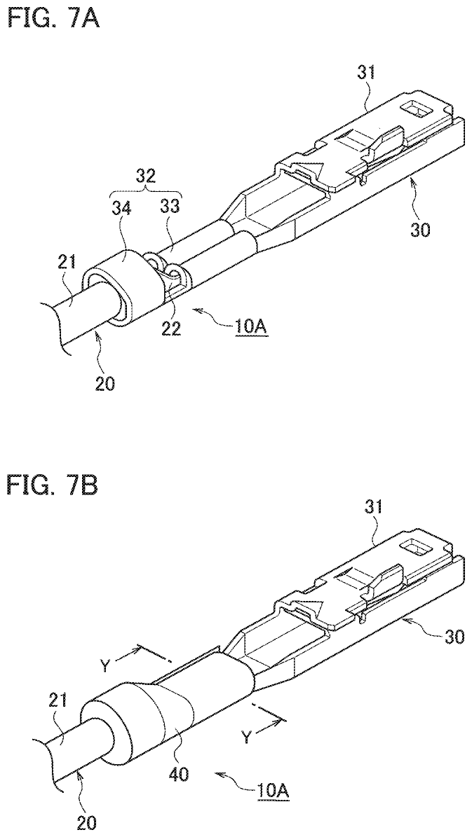

A second embodiment will be described with reference to FIGS. 7A to 11.

In a cable 10A with a terminal (see FIGS. 7A and 7B), by rotating the crimp terminal 30, the anticorrosion tape material 40 is wound and stuck around the crimping portion 32 including the core wire barrel (core wire crimping portion) 33 and the sheathed barrel (sheath crimping portion) 34. This point is different from the first embodiment. In addition, since other configurations are the same as those of the first embodiment, the same reference numerals are given to the same components and the detailed description is omitted.

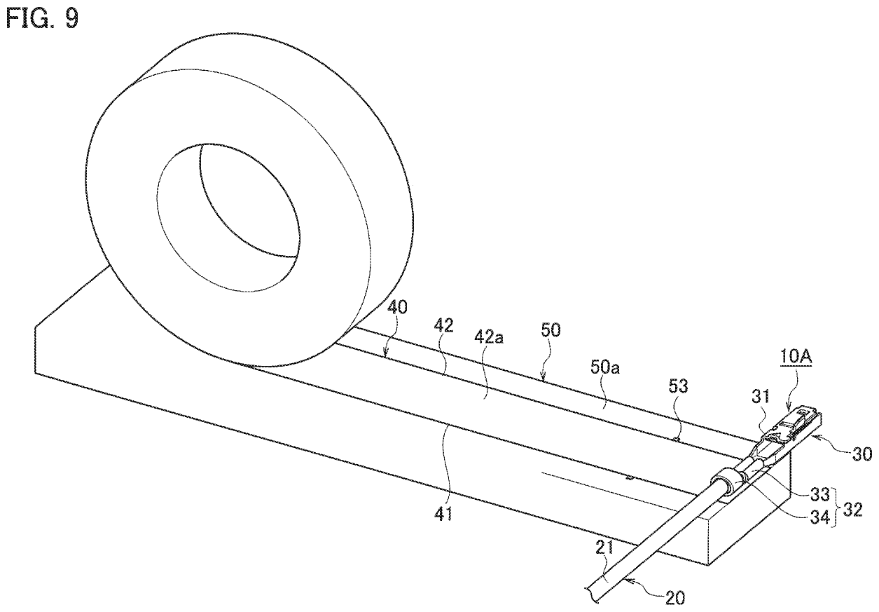

A method of manufacturing a cable 10A with a terminal will be described in order along FIGS. 9 to 11.

By a caulking die formed of a crimper, an anvil, and the like, the core wire 22 exposed from the insulating sheath 21 of the cable 20 is crimped to the core wire barrel 33 of the crimp terminal 30 beforehand, and the insulating sheath 21 of the cable 20 is crimped and connected to the sheathed barrel 34 of the crimp terminal 30.

As illustrated in FIG. 9, the anticorrosion tape material 40 is set on the upper surface 50a of the sticking jig 50 with the adhesive surface (bonded surface) 42a of the anticorrosion tape material 40 facing up. Then, the crimping portion 32 including the core wire barrel 33 and the sheathed barrel 34 of the crimp terminal 30 is set on one end side of the adhesive surface 42a of the anticorrosion tape material 40.

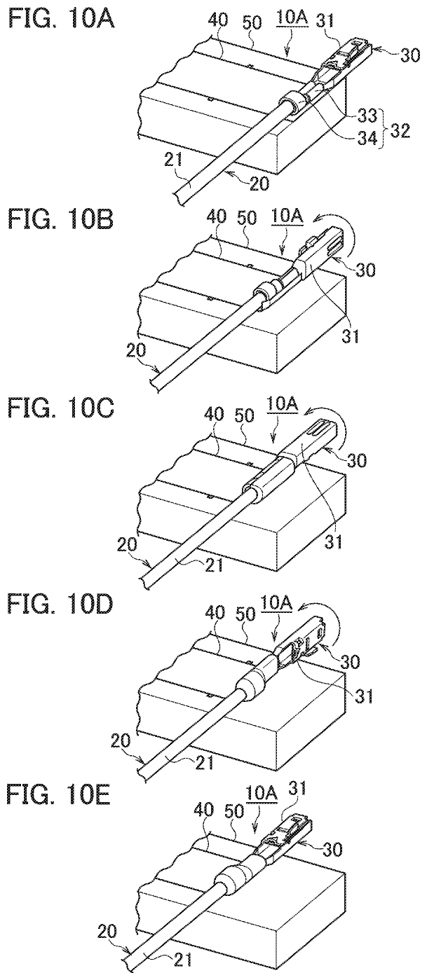

Next, as illustrated in FIGS. 10A to 10E, a rotation device (not illustrated) rotates the crimp terminal 30 set on the adhesive surface 42a of the anticorrosion tape material 40, and the anticorrosion tape material 40 is wound around the crimping portion 32 of the crimp terminal 30.

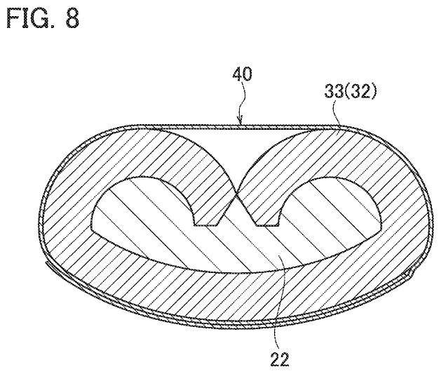

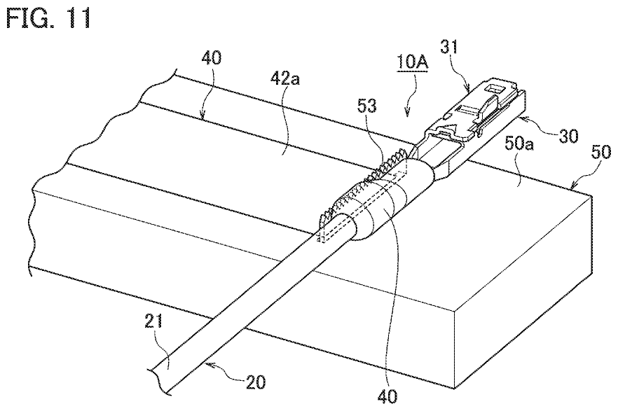

Then, as illustrated in FIG. 11, an excess portion of the wound anticorrosion tape material 40 is cut with the tape cutter 53 provided on the upper surface 50a of the sticking jig 50 in a retractable manner. Thereby, as illustrated in FIG. 8, the anticorrosion tape material 40 is stuck and bonded around the crimping portion 32 of the crimp terminal 30.

As illustrated in FIG. 8, there is a partial gap between the crimping portion 32 of the crimp terminal 30 and the anticorrosion tape material 40 wound around the crimping portion 32. The anticorrosion tape material 40 may be pressed against the gap between the anticorrosion tape material 40 and the crimping portion 32 to eliminate the gap.

As described above, by winding the anticorrosion tape material 40 around the crimping portion 32 of the crimp terminal 30, the electrolytic corrosion (different metal contact corrosion) of the core wire 22 of the cable 20 can be prevented simply and reliably.

By winding the anticorrosion tape material 40 around the crimping portion 32 of the crimp terminal 30, the electrolytic corrosion of the core wire 22 of the cable 20 can be prevented, so the lifetime of the crimping portion 32 can be extended.

By winding the anticorrosion tape material 40 around the crimping portion 32 of the crimp terminal 30, the electrolytic corrosion of the core wire 22 of the cable 20 can be prevented, so the improvement in productivity and the cost reduction can be achieved. In addition, there is no need to change the conventional terminal structure.

In addition, the crimp terminal 30 is rotated to wind the anticorrosion tape material 40 around the crimping portion 32, but this embodiment is not limited thereto. For example, the anticorrosion tape material 40 may be rotated around the crimping portion 32 of the crimp terminal 30 to wind the anticorrosion tape material 40 around the crimping portion 32 of the crimp terminal 30.

What is claimed is:

1. A cable with a terminal, comprising:
a cable which has a core wire covered with an insulating sheath; and
a crimp terminal which has a crimping portion including a core wire crimping portion crimped to the core wire exposed from the insulating sheath and a sheath crimping portion crimped to the insulating sheath,
wherein an anticorrosion tape material is stuck around the crimping portion of the crimp terminal.

2. The cable with a terminal according to claim 1, wherein adhesive surfaces of the anticorrosion tape material are stuck to each other in a state where the crimp terminal is restrained, and the anticorrosion tape material is stuck around the crimping portion of the crimp terminal.

3. The cable with a terminal according to claim 1, wherein the anticorrosion tape material is wound and stuck around the crimping portion of the crimp terminal by rotating the crimp terminal.

4. A method of manufacturing a cable with a terminal which includes a cable which has a core wire covered with an insulating sheath, and a crimp terminal which has a crimping portion including a core wire crimping portion crimped to the core wire exposed from the insulating sheath and a sheath crimping portion crimped to the insulating sheath, the method comprising:
winding an anticorrosion tape material around the crimping portion of the crimp terminal after the cable is crimped and connected to the crimping portion of the crimp terminal.

5. The method of manufacturing a cable with a terminal according to claim 4, wherein the anticorrosion tape material is set on a recess portion of a sticking jig, the crimping portion of the crimp terminal is pressed against the anticorrosion tape material set on the recess portion of the sticking jig, and
after adhesive surfaces of the anticorrosion tape material are stuck to each other, the anticorrosion tape material is cut and the anticorrosion tape material is stuck and bonded around the crimping portion of the crimp terminal.

6. The method of manufacturing a cable with a terminal according to claim 4, wherein the adhesive surface of the anticorrosion tape material is set to face up,
the crimp terminal is set on the adhesive surface of the anticorrosion tape material, and
the anticorrosion tape material is wound and bonded around the crimping portion of the crimp terminal by rotating the crimp terminal.
